(19) United States
(12) Patent Application Publication
(10) Pub. No.: US 2007/0150660 A1
(43) Pub. Date: Jun. 28, 2007

(54) Inserting prefetch instructions based on hardware monitoring

(76) Inventors: Jaydeep P. Marathe, Raleigh, NC (US); Dong-Yuan Chen, Fremont, CA (US); Ali-Reza Adl-Tabatabai, Menlo Park, CA (US); Anwar Ghuloum, Mountain View, CA (US); Ara V. Nefian, San Jose, CA (US)

Correspondence Address: TROP PRUNER & HU, PC, 1616 S. VOSS ROAD, SUITE 750, HOUSTON, TX, 77057-2631, US

(21) Appl. No.: 11/320,201

(22) Filed: Dec. 28, 2005

(51) Int. Cl. G06F 12/00

(52) U.S. Cl. 711/137

(57) ABSTRACT

A compiler or runt-time system may determine a prefetch point to insert an instruction in order to prefetch a memory location and thereby reduce latency in accessing information from a cache. A prefetch predictor generator may decide where and whether to insert the appropriate instructions by looking at information from a hardware monitor. For example, information about cache misses may be analyzed. The differences between target addresses of those cache misses for different instructions may be determined. This information may also be used to determine the locations in the program where the prefetch instructions should be placed, as well as to calculate the address of the memory location being prefetched.

### BACKGROUND

This invention relates generally to compilers and run-time systems and, more particularly, to inserting prefetch instructions.

In order to improve and optimize performance of processor systems, prefetching techniques are used to reduce effective latencies for memory accesses on processor systems. In particular, in data prefetching, data that may be needed for an operation may be prefetched into a cache, so that it is available when needed. Thus, data prefetching involves anticipating the need for data access requests. Prefetching may seek to avoid cache misses associated with certain data addresses.

Prefetching addresses the memory latency problem by prefetching data into processor caches prior to their use. To prefetch in a timely manner, the processor needs to prefetch an address early enough to overlap the prefetch latency with any other computation and/or latency.

Software-based data prefetching attempts to insert a prefetch instruction at a program location called the “prefetch point” well before the data item is to be loaded in the future, in the hope of bringing the data item into the cache before it is needed. The instruction address of the prefetch point is called the “prefetch point instruction pointer” (prefetch point IP) and the load instruction address, where the data item is actually loaded, is called the “target instruction pointer” (target IP). At the prefetch point, the prefetch instruction needs to know the address, called the prefetch target address, of the expected data item. The prefetch target address can only be computed from data available at the prefetch point. To reduce the overhead of software-based prefetching, the computation of the prefetch target address should be derivable from the data available at the prefetch point, preferably involving only simple calculations. For example, the prefetch target address may be the sum of the base address and the offset from the base address. Then, the base address and the offset must be a value readily available at the prefetch point.

A prefetch predictor may be a tuple of form <prefetch point IP, base address, offset value>. It represents a potential prefetch instruction to be inserted at the prefetch point specified by the instruction pointer and targeting the address at (base address+offset). The base address is available at the prefetch. To achieve effective data prefetching, it is desirable to find a set of prefetch predictors such that the data located at the address computed using the base address and offset fields of the predictor is accessed with a high probability soon after the instruction at the prefetch point is executed.

### BRIEF DESCRIPTION OF THE DRAWINGS

FIG. 1 is a flow diagram for a process in accordance with one embodiment of the present invention;

FIG. 2 is a schematic depiction of the development of a list of deltas and delta counts in accordance with one embodiment of the present invention;

FIG. 3 is a depiction of a system in accordance with one embodiment of the present invention; and

FIG. 4 is a hardware depiction of one embodiment of the present invention.

### DETAILED DESCRIPTION

In accordance with some embodiments of the present invention, it is possible to determine the prefetch point IP sufficiently in advance of a data load point such that data at a prefetch target address may be brought in ahead of time to make it available for use to reduce effective data access latency. To accomplish this, hardware monitor information may be utilized to predict when it is desirable to insert an instruction to prefetch particular data. The hardware monitor information may be manipulated in a number of ways to make the data more meaningful. In one case, deltas are calculated between the target addresses of load instructions that miss in the data cache, in order to predict where the next data item will be obtained when the first load instruction is executed. Using that information, the target address may be prefetched by an instruction inserted at an appropriate location within the program code.

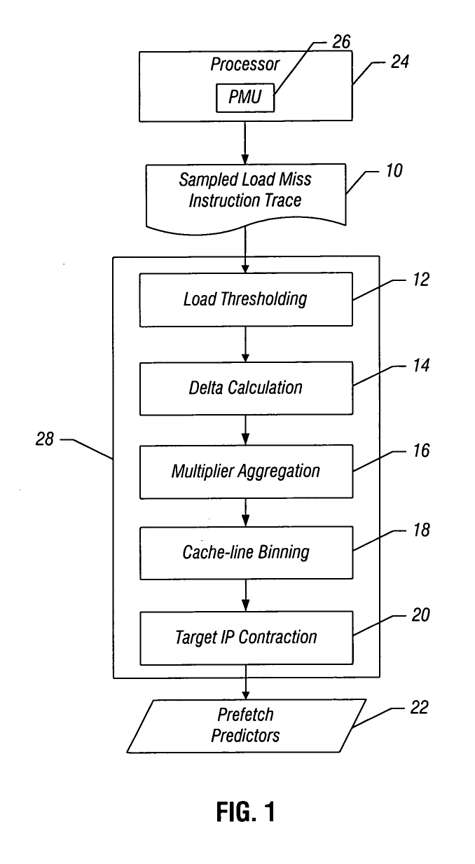

Referring to FIG. 1, a processor 24 may execute code which has either been compiled offline or been compiled and linked dynamically during program execution. In the course of executing that code, the processor may use hardware monitor to monitor its own operations.

Particularly, some processors 24 include a so-called performance monitor unit (PMU) 26 that is programmable to specify a number of events that may be recorded and provided as an output for performance monitoring. In some embodiments, performance monitor configuration registers may be used to configure performance monitors. Performance monitor data registers provide data values from the monitors. The data from the monitors may be in the form of counts of numbers of specified events.

Some performance monitors include monitoring registers for instruction and data event address registers (EARs) for monitoring cache and translation look aside buffer misses, branch trace buffers, opcode match registers, and instruction address range check registers. The data event address configuration register may be programmed to monitor L1 data cache load misses, L1 data translation look aside misses, or other misses. Other embodiments of hardware monitors or performance monitoring units are also contemplated.

The output data from the performance monitor unit 26 may include an instruction address, a data address, and a latency value. This information may be presented in three separate registers. A latency filter may be specified, based on a threshold, which may be programmed. In other words, only events which have a latency value above the programmed threshold may be recorded. The latency value is normally presented in central processing unit (CPU) clocks.

Multiple loads may be outstanding at any point in a time window. A data cache miss event address register only tracks a single load within the time window. Therefore, not all of the cache load misses may be captured by the PMU 26.

For simplicity, only load instructions are discussed herein as the prefetch point instruction. However, the instruction at a prefetch point instruction pointer may be any instruction. In addition, for simplicity, only the target address of the load at the prefetch point instruction pointer is used as the prefetch base address. However, the prefetch base address could be any value available at the prefetch point instruction pointer.

The instruction pointer of a load instruction (LIP) and the target address of the load (LTA) may be specified for the load instructions in a load miss instruction trace 10. The load miss instruction trace is a sampled load miss instruction trace in this example. It is “sampled” because, in some embodiments, the performance monitoring unit 26 does not provide all the missed instructions but, rather, only those that it can record.

Target address deltas may be determined between the target addresses of a pair of load instructions in the sampled load miss instruction trace as LTAᵢ₊ₘ−LTAᵢ for some LIPᵢ and LIPᵢ₊ₘ in the trace, where m is less than or equal W and greater than or equal to 1. Here, W is some window size within which pair-wise target address deltas are computed. To form a prediction, we want to find a location at LTAₚₚ plus a constant C is likely to be accessed after LIPₚₚ in the near future. Hence the tuple (LIPₚₚ, LTAₚₚ, C) is a prefetch predictor for data prefetch. The problem, then, is to find the LIPₚₚ and the constant C associated with LIPₚₚ efficiently from the sampled load miss instruction trace 10. That is precisely what the prefetch prediction engine 28 seeks to accomplish. The prefetch prediction engine 28 extracts data from the load miss instruction trace 10 and suggests inserting a prefetch instruction at a location to access an address that is likely to be requested and to result in a cache miss in the future. Such a prefetch can be issued in the shadow of the load miss to take advantage of available parallelism in the memory hierarchy.

The specific data that is sampled to generate the sampled load miss instruction trace 10 may be programmable, limited only by the performance of the hardware monitor 26. However, in some embodiments, the performance monitor unit 26 may be programmed to capture only certain load instructions, such as those that miss a particular cache. Since the sampled load miss instruction trace 10 effectively comes from a random sampling of the load miss instructions at very fine granularity, the discovery of the constant C is challenging.

The prefetch prediction engine 28 initially uses load thresholding 12 to reduce the relatively high number of load miss instruction information that may be received. The load thresholding 12 removes load instructions that are insignificant or irrelevant to the prefetch prediction engine 28 so that the predictor only examines the important load instructions. Those load instructions that are important are those that appear frequently in the sampled load miss instruction trace.

Therefore, the load thresholding may be achieved by thresholding all the load IPs in the trace. If the number of samples in load miss instruction trace that correspond to a particular load instruction is greater than a predetermined percentage threshold, then that load instruction is denoted as a delinquent load. Only delinquent loads may be selected for consideration in the next step in some embodiments. The instruction addresses of the selected instructions are denoted as the delinquent load IPs. The selection of the base samples depends on the actual usage model of the prefetch prediction engine 28. For example, if the prefetch predictor 28 is used in an offline model, such as a profile-guided compilation, the base samples may be the whole sampled load miss instruction trace. A pass over the trace may be done before the prefetch predictor generation to construct a histogram of all the load miss instruction pointers. If the prefetch predictor generation is used in an online model or a dynamic model, the base samples may consist of all the samples seen up to the point when thresholding a particular load miss instruction pointer. The running histogram of all the samples up to the load miss instruction pointer of interest may be used for thresholding.

Next, the calculation of the actual delta values may occur at 14. The delta calculation computes and detects constant deltas between the load miss target addresses of a pair of delinquent loads in a small window, based on load miss instructions that pass through the load thresholding 12.

The theory is that if a certain load instruction pointer LIPₚₚ is seen that has a load target address LTAₚₚ, then sometimes you can predict that after the instruction at LIPₚₚ is executed, the location at (LTAₚₚ plus a constant distance) will be accessed in the near future. So, if you look at the frequency with which load target address deltas repeat frequently for a given LIP, you can find situations where after the instruction at LIP is executed you can predict a future location will be accessed shortly. If you know that access is one that often results in a cache miss then you know it is desirable to prefetch for the likely upcoming access, that otherwise would result in a cache miss.

The delta calculation looks at delinquent loads with a sliding window of size W. Let LTAₖ denote the target address of the memory location accessed by the load instruction LIPₖ. Within the sliding window, the difference or delta of the load target addresses between the first load at LIPₖ and the i-th load at LIPₖ₊ᵢ₋₁ is computed (i.e. LTAₖ₊ᵢ₋₁−LTAₖ) for all i greater than 1 and less than or equal to W.

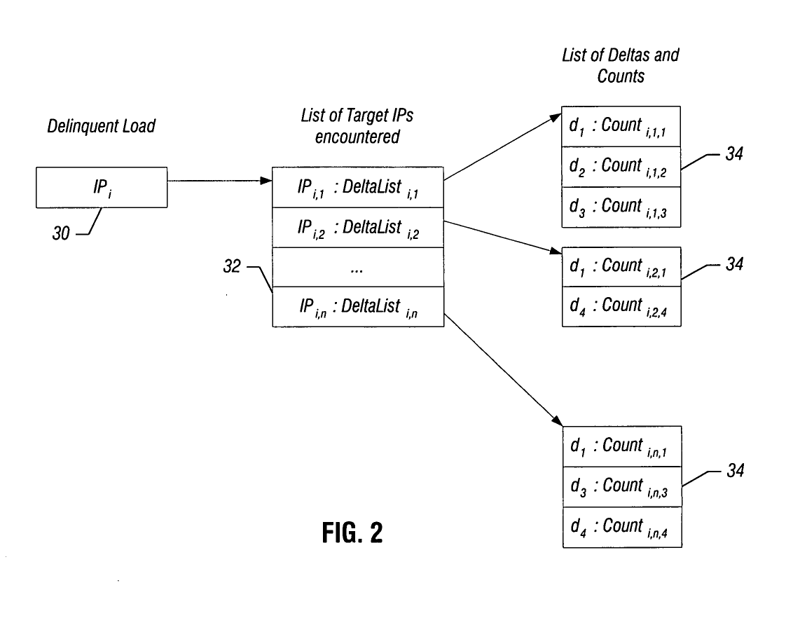

After delta calculation, a data structure is maintained for each delinquent load instruction IPᵢ that records the deltas between IPᵢ and all other delinquent load instructions in the slide window W. Referring to FIG. 2, the delinquent load instruction pointer IPᵢ is indicated at 30. A list of target delinquent load instruction pointers that are encountered within the window of size W is indicated at 32 and a list of deltas and delta counts for each (IPᵢ, IP_{i,j}) pair is indicated at 34. Thus, the delta values are recorded in the delta list associated with a target IP, IP_{i,j} in a two-level delta map structure for the load at IPᵢ. Once the target calculation is done for the current window, the window may then be shifted one element to the right in the filtered trace. For each delinquent load 30 at IPᵢ there is a map of all the target delinquent loads that fall with the window of size W during the sliding window delta calculation run, as indicated at 32. For each such target delinquent load (IP_{i,1}, IP_{i,2}, . . . IP_{i,n}) there is a second level map, indicated at 34, that records all the deltas associated with IPᵢ in the trace, along with a count C of how many times the delta was encountered.

The count C in the delta list 34 is actually recorded as a pair (Cₙₑₐᵣ, C_{far}), where C=Cₙₑₐᵣ+C_{far}. The first element in the sliding window is assumed to be IPᵢ, TAᵢ, and we are computing the delta with respect to the k-th element (IPᵢ₊ₖ₋₁, TAᵢ₊ₖ₋₁) in the window. The delta between the two elements is d=TAᵢ₊ₖ₋₁−TAᵢ. Depending on where the target address TAᵢ of the first element is located in the cache line, the location of TAᵢ+d may be in one of two cache lines. For example, if the cache line size is 128 bytes and the delta d is 143, then if TAᵢ is within the first 113 bytes of a cache line, TAᵢ+d will be in the cache line next to that of TAᵢ. If TA is not in the first 113 bytes of TAᵢ's cache line, TAᵢ+d will be two cache lines away from TAᵢ's cache line.

The cache line that is closer to TAᵢ is denoted as the near cache line and the one farther away is denoted as the far cache line. Depending on the location of TAᵢ and whether TAᵢ₊ₖ₋₁ falls in the near cache line with respect to TAᵢ, the counter Cₙₑₐᵣ or C_{far} is incremented respectively during the delta calculation. The Cₙₑₐᵣ and C_{far} counters may be used in the cache line binning described later.

Thus, the two-level delta map, shown in FIG. 2, constitutes an unrefined form of a prefetch vector that will be further refined in the ensuing operations.

Referring to FIG. 1, the next operation may be multiplier aggregation 16. Due to the lossy nature of the sampled load miss instruction trace 10, regular deltas between loads may appear to be irregular. For example, suppose that there is a regular delta D from one instance of a load L to the next instance of the same load in the load miss instruction trace. The load L then accesses locations X, X+D, X+2D, X+3D in the actual load miss instructions. However, in the sampled load miss instruction trace, the load L may appear to access only locations at X, X+2D, X+3D, and X+6D, instead. The multiplier aggregation 16 overcomes the delta irregularity introduced by the sampled load miss instruction trace.

In the multiplier aggregation 16, the delta and count lists 34 in the two-level delta map, shown in FIG. 2, are scanned. Delta d is a multiplier of delta dₙ (that is, dₘ=dₙ×D, for some constant integer D). In the delta list we add the count for dₘ to the count for dₙ as well. The multiplier aggregation 16 effectively makes a count of the delta D to be the total count of the deltas D, 2D, 3D, 4D, etc.

For the purpose of data prefetching, it is desirable to bring in the cache line that contains the locations that will be accessed in the near future. Hence, it is the cache line delta that is useful for the data prefetch instead of the actual delta values. In the cache line binning 18, the actual deltas are reduced into cache line deltas. The cache line deltas are deltas in multiples of the cache line size. The cache line binning 18 effectively reduces the number of deltas and, thus, the number of prefetch predictors to be considered for a data prefetch.

For cache line binning, each of the original delta list elements is examined one-by-one. For each element with a delta d and a count C, we compute the near cache line delta and the far cache line delta for the delta d. Then, the two elements are added to the new cache line bin list that takes the place of the original delta list. If a cache line delta value already exists in the cache line bin list, the count is added to the existing counter value. After the cache line binning 18, the only delta values left are all multiples of the cache line size in some embodiments.

It is sometime desirable to maintain the target IP information for each prefetch predictor IP in the prefetch predictor 22. If it is so required, the prefetch predictor 22 can easily extract the target IP information for each prefetch predictor IP from the two-level delta maps structure coming out of the cache line binning 18. However, if the target IP is determined to be not needed, the target IP contraction 20 may be performed to aggregate all the delta lists under different target IPs under one prefetch predictor IP.

The prefetch predictors 22 can be further ranked with different metrics in some embodiments. For example, each prefetch predictor 22 may be weighted by the count value of each delta. Additional information, such as the accumulated actual load latency values from the PMU 26 samples, may also be used in prioritizing the prefetch predictors. The result from the prefetch generation engine 28 is a list of ranked prefetch predictors 22 that are ready for use by prefetch modules.

The prefetch generation engine 28 can be used in various circumstances. In an offline compilation environment, one can collect a sampled load miss instruction trace in a profile run using a representative input set. The prefetch generation can then be a separate preprocessing program that takes the trace and generates a list of prefetch predictors for the profile-guided compilation run. During the profile-guided compilation run, the compiler may make software-based prefetch decisions based on the prefetch predictors. The prefetch generation engine 28 may also be part of a profile guided compiler that takes the trace as part of its profile input.

In a dynamic or online environment, the prefetch generation engine 28 may be part of the dynamic compilation or optimization system. The online compilation system may control the dynamic collection of sampled load miss instruction case, feeding the trace into the prefetch generation engine 28 during program execution. The prefetch generation engine produces a list of prefetch predictors, based on the dynamic trace. The dynamic compilation system then makes prefetch decisions in a dynamic compilation or optimization phase based on the generated list of prefetch predictors.

In either the offline or online environments, prefetch generation can be used, regardless of whether the compilation or optimization is done on a source code or in a binary format. That is, some embodiments of the present invention may be used during compile time and other embodiments may be used during run time.

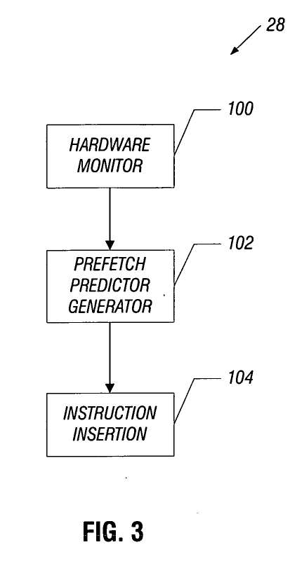

Thus, referring to FIG. 3, a hardware monitor 100 may be used as part of a prefetch generation engine 28. The output from the hardware monitors, such as a PMU 26, is provided to a prefetch predictor generator 102. The prefetch predictor generator 102 calculates the delta values and provides them after any appropriate modifications to an instruction insertion unit 104. The instruction insertion unit 104 actually inserts the instruction at the prefetch point in order to access the prefetch target address and to ensure that the data is available by the data load point. In one embodiment, the generator 102 may be a delta calculator.

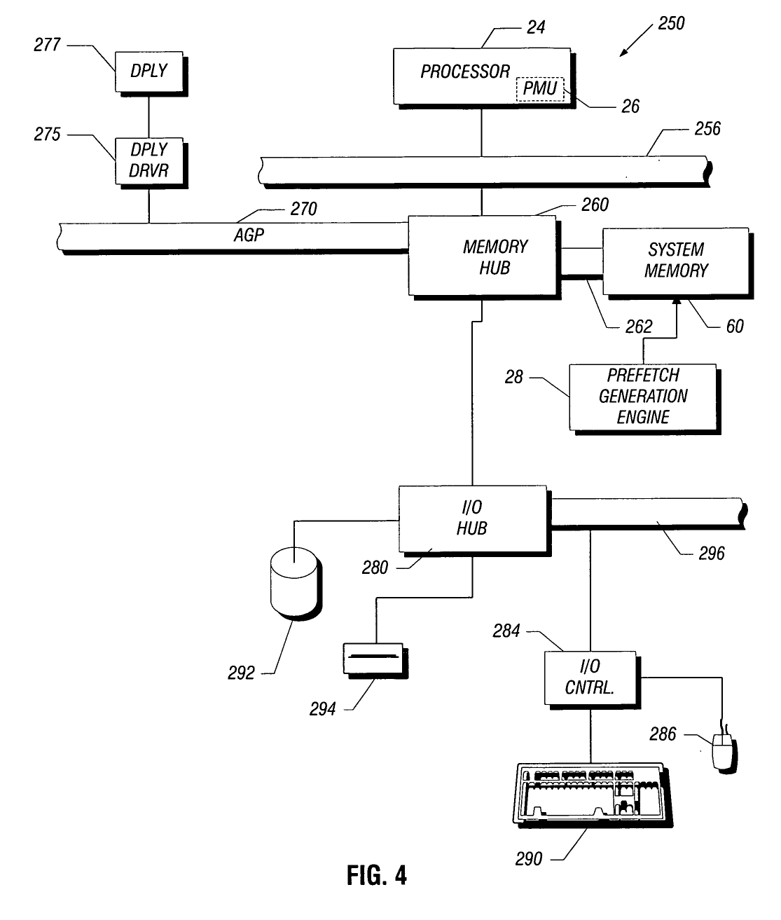

FIG. 4 depicts a schematic diagram of a computer system 250, such as a desktop computer, a laptop computer, or a server, in accordance with some embodiments, although other embodiments and other architectures are within the scope of the appended claims.

The computer system 250 includes the processor 24 which may be one or more microprocessors coupled to a local or system bus 256. A northbridge or memory hub 260 is also coupled to the local bus 256 and establishes communication between the processor 24, a system memory bus 262, an accelerated graphics port (AGP) bus 270, and a peripheral component interconnect (PCI) bus 256. The AGP specification is described in detail in the Accelerated Graphics Port Interface Specification, rev. 1.0, published on Jul. 31, 1996 by Intel Corporation of Santa Clara, Calif. The PCI specification is available from the PCI special interest group, Portland, Oreg. 97214.

A system memory 60, such as a dynamic access memory, for example, is coupled to the system memory bus 262. The compiler program that includes the prefetch generation engine 28 may, for example, be executed by the processor 24, causing the computer system 250 to perform the technique described in FIG. 1.

Still referring to FIG. 4, among the other features, the computer system 250 may include a display driver interface 275 that couples a display 277 to the AGP bus 270. Furthermore, a network interface card (NIC) 273 may be coupled to the PCI bus 256 in some embodiments of the present invention. A hub link may couple the memory hub 260 to a south bridge or input/output (I/O) hub 280. The I/O hub 280 may provide interfaces for a hard disk drive 292 and a CD ROM drive 294, for example. Furthermore, the I/O hub 280 may provide an interface to an I/O expansion bus 296. An I/O controller 284 may be coupled to the I/O expansion bus 296, providing interfaces receiving input data from a mouse 286, as well as a keyboard 290.

In some embodiments, the flow diagram in FIG. 1 may represent machine-readable instructions that may be executed by a processor to insert prefetch instructions, as illustrated in FIG. 3. The instructions may be implemented in many different ways, utilizing any of many different programming codes stored on any of the many computer or machine-readable mediums such as volatile or non-volatile memory or other mass storage devices. For examples, the machine-readable instructions may be embodied in a machine-readable medium such as a read only memory, a random access memory, a magnetic media, an optical media, or any other suitable type of medium. Alternatively, the machine-readable instructions may be embodied in hardware such as in a programmable gate array or an application-specific integrated circuit. Further, although a particular order of actions is illustrated in FIG. 1, these actions can be performed in other temporal sequences. Again, the flow diagram of FIG. 1 is merely provided as an example of one way to insert prefetch instructions.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
inserting a prefetch instruction based on the difference between target addresses of previous cache misses for different instructions.

2. The method of claim 1 including receiving information from a hardware performance monitor of a processor.

3. The method of claim 2 including extracting information about cache misses from said hardware performance monitor.

4. The method of claim 3 including setting a threshold for the number of times an instruction is subject to a cache miss and using only cache misses that exceeds said threshold to determine where to insert said prefetch instruction.

5. The method of claim 3 including determining a difference between target addresses and the number of times that said difference occurs.

6. The method of claim 1 including determining a missing difference in a series of target address differences and providing said missing difference.

7. The method of claim 1 including determining the differences within a window and then moving the window.

8. The method of claim 7 including reducing the differences to differences in cache line distances.

9. The method of claim 7 including developing indications of prefetch insertion points and ranking the indications based on the count value of target address differences associated with said indications.

10. The method of claim 1 including inserting a prefetch instruction in an offline compilation environment.

11. The method of claim 1 including inserting said prefetch instruction in a dynamic, on-line environment.

12. A computer readable medium storing instructions that, when executed, enable a processor-based system to:
insert a prefetch instruction based on the difference between target addresses of previous cache misses for different instructions.

13. The medium of claim 12 further storing instructions that, when executed, enable a processor-based system to receive information from a hardware performance monitor.

14. The medium of claim 13 further storing instructions that, when executed, enable a processor-based system to extract information about cache misses from said hardware performance monitor.

15. The medium of claim 14 further storing instructions that, when executed, enable a processor-based system to set a threshold for the number of times an instruction is subject to a cache miss and use only cache misses that exceed said threshold to determine where to insert said prefetch instruction.

16. The medium of claim 14 further storing instructions that, when executed, enable a processor-based system to determine a difference between target addresses and to also determine the number of times that said difference occurs.

17. The medium of claim 12 further storing instructions that, when executed, enable a processor-based system to determine a missing difference in a series of target address differences and provide said difference.

18. The medium of claim 14 further storing instructions that, when executed, enable a processor-based system to determine the differences between target addresses within a window and then move the window.

19. The medium of claim 18 further storing instructions that, when executed, enable a processor-based system to reduce the differences to differences in cache line distances.

20. The medium of claim 18 further including storing instructions that, when executed, enable a processor-based system to develop indications of prefetch instruction points and to rank the indications based on the count value and target address differences associated with said indication.

21. The medium of claim 12 further storing instructions that, when executed, enable a processor-based system to insert said prefetch instruction in an offline compilation environment.

22. The medium of claim 12 further storing instructions that, when executed, enable a processor-based system to insert said prefetch instruction in a dynamic, online environment.

23. An apparatus comprising:
a hardware monitor;
a prefetch predictor generator to calculate the difference between target addresses of cache misses for different instructions detected by said hardware monitor; and
a device to insert instructions for prefetching a target address.

24. The apparatus of claim 23 wherein said hardware monitor is a performance monitor unit to detect data event address for cache misses.

25. The apparatus of claim 23 wherein said generator to receive a cache miss instruction trace from said hardware monitor.

26. The apparatus of claim 23 wherein said generator to determine a threshold for the number of times an instruction results in a cache miss.

27. A system comprising:
a processor, said processor including a hardware monitor; and
a prefetch predictor generator coupled to receive the output from said hardware monitor in the form of a series of cache miss instructions, said generator to calculate the distance between target addresses of missed instructions.

28. The system of claim 27, said generator to operate in an offline compilation environment.

29. The system of claim 27, said generator to operate in a dynamic online environment.

30. The system of claim 27, said generator to determine a series of prefetch predictors and to rank said prefetch predictors.
